(19) United States
(12) Patent Application Publication
(10) Pub. No.: US 2017/0104251 A1
(43) Pub. Date: Apr. 13, 2017

(54) BATTERY PACK RETENTION DEVICE AND METHOD

(71) Applicant: FORD GLOBAL TECHNOLOGIES, LLC, Dearborn, MI (US)

(72) Inventor: Yongcai Wang, Ann Arbor, MI (US)

(21) Appl. No.: 14/881,282

(22) Filed: Oct. 13, 2015

(51) Int. Cl. H01M 10/6556; H01M 10/625

(52) U.S. Cl. CPC H01M 10/6556; H01M 10/625; H01M 2220/20

(57) ABSTRACT

An exemplary battery pack retention device includes a first loop configured to engage a first port assembly of a battery module, a second loop configured to engage a second port assembly of the battery module, and a transition section coupling the first loop to the second loop. An exemplary battery pack manifold retention method includes coupling a first manifold section to a first coolant fin with a first port assembly, coupling a second manifold section to a second coolant fin with a second port assembly, and limiting relative movement between the first and second port assemblies to maintain the first manifold section in an engaged position with the second manifold section.

### TECHNICAL FIELD

This disclosure relates to a retention device and, more particularly, to a retention device that holds coolant manifolds of a battery pack in an engaged position.

### BACKGROUND

Electrified vehicles differ from conventional motor vehicles because electrified vehicles are selectively driven using one or more electric machines powered by a battery pack. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

Some battery packs are liquid cooled. An inlet manifold communicates coolant to coolant fins that are each sandwiched between battery cells of the battery pack. The coolant takes on heat as the coolant moves through the coolant fins. An outlet manifold communicates the heated coolant away from the coolant fins. The inlet and outlet manifolds can each include several individual sections that are joined during assembly.

### SUMMARY

A battery pack retention device according to an exemplary aspect of the present disclosure includes, among other things, a first loop configured to engage a first port assembly of a battery module, a second loop configured to engage a second port assembly of the battery module, and a transition section coupling the first loop to the second loop.

In a further non-limiting embodiment of the foregoing battery pack retention device, the first loop and a first end portion of the transition section are configured to circumscribe the first port assembly.

In a further non-limiting embodiment of any of the foregoing battery pack retention devices, the second loop and a second end portion of the transition section are configured to circumscribe the second port assembly, the first end portion opposite the second end portion.

In a further non-limiting embodiment of any of the foregoing battery pack retention devices, the first loop provides an opening to slideably receive the first port assembly, and the second loop provides an opening to slideably receive the second port assembly.

In a further non-limiting embodiment of any of the foregoing battery pack retention devices, the first loop, second loop, and transition section are portions of a continuous, monolithic structure.

In a further non-limiting embodiment of any of the foregoing battery pack retention devices, the first port assembly includes a fin port that communicates a coolant to or from a first coolant fin sandwiched between battery cells, and the second port assembly comprises a fin port that communicates a coolant to or from a second coolant fin sandwiched between battery cells.

In a further non-limiting embodiment of any of the foregoing battery pack retention devices, the transition section includes a first layer and a second layer. The first layer couples an upper portion of the first loop to an upper portion of the second loop. The second layer couples a lower portion of the first loop to a lower portion of the second loop.

In a further non-limiting embodiment of any of the foregoing battery pack retention devices, the first layer is directly secured to the second layer.

According to another exemplary aspect of the present disclosure, a battery pack assembly includes a first battery module disposed along an axis, a second battery module disposed along the axis, and a retention device configured to engage a first port assembly of the first battery module and a second port assembly of the second battery module.

In a further non-limiting embodiment of the foregoing battery pack, the assembly includes an end frame positioned between the first and second battery modules. A portion of retention device is axially aligned with the end frame.

In a further non-limiting embodiment of any of the foregoing battery packs, a first coolant fin provides at least a portion of the first port assembly, and a second coolant fin provides at least a portion of the second port assembly.

In a further non-limiting embodiment of any of the foregoing battery packs, the battery pack includes a first section of a coolant manifold engaged with a second section of the coolant manifold. The first section provides at least a portion of the first port assembly and the second section provides at least a portion of the second port assembly.

In a further non-limiting embodiment of any of the foregoing battery packs, the battery pack includes a first gasket to seal an interface of the first port assembly, and a second gasket to seal an interface of the second port assembly.

A battery pack manifold retention method according to yet another exemplary aspect of the present disclosure includes, among other things, coupling a first manifold section to a first coolant fin with a first port assembly, coupling a second manifold section to a second coolant fin with a second port assembly, and limiting relative movement between the first and second port assemblies to maintain the first manifold section in an engaged position with the second manifold section.

In a further non-limiting embodiment of the foregoing method, the method includes limiting by holding a portion of the first port assembly within a first loop of a retention device and by holding a portion of the first port assembly within a second loop of the retention device.

In a further non-limiting embodiment of any of the foregoing methods, the first port assembly and the second port assembly each comprise a fin port and a conduit port.

In a further non-limiting embodiment of any of the foregoing methods, the first port assembly includes a first gasket and the second port assembly includes a second gasket, the first loop directly contacts the first gasket and the second loop directly contacts the second gasket during the limiting.

In a further non-limiting embodiment of any of the foregoing methods, the first coolant fin is directly adjacent at least one battery cell within a first battery module disposed along an axis, and the second coolant fin is directly adjacent at least one battery cell within a second battery module disposed along the axis. The first battery module is axially separated from the second battery module by a first end frame of the first module and a second end frame of the second battery module. The first and second end frames axially aligned with a transition section of the retention device.

In a further non-limiting embodiment of any of the foregoing methods, the first manifold section and the second manifold section are disclosed along a common axis when in the engaged position, and the limiting includes limiting relative movement of the first manifold section away from the second manifold section along the axis.

In a further non-limiting embodiment of any of the foregoing methods, the relative movement is initiated by an expansion of at least one battery cell within a battery pack.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows a powertrain of an example electrified vehicle.

FIG. 2 shows a partially schematic perspective view of a battery pack from the powertrain of FIG. 1.

FIG. 3 shows a schematic, exploded view of a portion of a battery module from the battery pack of FIG. 2.

FIG. 4 shows two battery modules from the battery pack of FIG. 2.

FIG. 5 shows a top view of portions of manifold sections coupling to coolant fins of the battery modules during assembly.

FIG. 6 shows a top view of portions of manifold sections coupled to coolant fins of the battery modules.

FIG. 7 shows a perspective view of an example battery pack retention device used within the battery pack of FIG. 2.

### DETAILED DESCRIPTION

This disclosure relates to a retention device used within a battery pack of an electrified vehicle. The retention device inhibits expanding battery cells from dislodging coolant manifolds. In particular, the retention device limits relative movement between port assemblies to maintain sections of coolant manifolds in engaged positions.

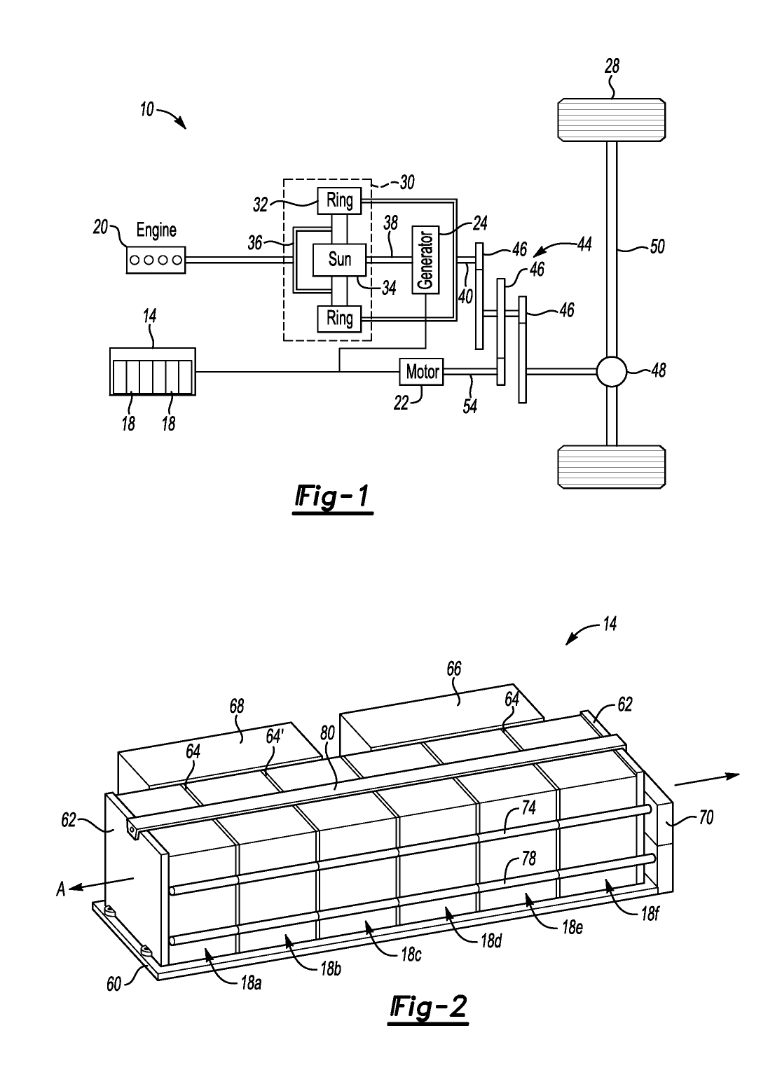

Referring to FIG. 1, a powertrain 10 of a hybrid electric vehicle (HEV) includes a battery pack 14 housing battery modules 18. Each battery module 18 includes from ten to twenty individual battery cells in this example. The battery modules 18 can include different numbers of battery cells.

The powertrain 10 further includes an internal combustion engine 20, a motor 22, and a generator 24. The motor 22 and the generator 24 are types of electric machines. The motor 22 and generator 24 may be separate or have the form of a combined motor-generator.

In this embodiment, the powertrain 10 is a power-split powertrain that employs a first drive system and a second drive system. The first and second drive systems generate torque to drive one or more sets of vehicle drive wheels 28. The first drive system includes a combination of the engine 20 and the generator 24. The second drive system includes at least the motor 22, the generator 24, and the battery pack 14. The motor 22 and the generator 24 are portions of an electric drive system of the powertrain 10.

The engine 20 and the generator 24 can be connected through a power transfer unit 30, such as a planetary gear set. Of course, other types of power transfer units, including other gear sets and transmissions, can be used to connect the engine 20 to the generator 24. In one non-limiting embodiment, the power transfer unit 30 is a planetary gear set that includes a ring gear 32, a sun gear 34, and a carrier assembly 36.

The generator 24 can be driven by the engine 20 through the power transfer unit 30 to convert kinetic energy to electrical energy. The generator 24 can alternatively function as a motor to convert electrical energy into kinetic energy, thereby outputting torque to a shaft 38 connected to the power transfer unit 30.

The ring gear 32 of the power transfer unit 30 is connected to a shaft 40, which is connected to the vehicle drive wheels 28 through a second power transfer unit 44. The second power transfer unit 44 may include a gear set having a plurality of gears 46. Other power transfer units could be used in other examples.

The gears 46 transfer torque from the engine 20 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 can be selectively employed to drive the vehicle drive wheels 28 by outputting torque to a shaft 54 that is also connected to the second power transfer unit 44. In this embodiment, the motor 22 and the generator 24 cooperate as part of a regenerative braking system in which both the motor 22 and the generator 24 can be employed as motors to output torque. For example, the motor 22 and the generator 24 can each output electrical power to recharge cells of the battery pack 14.

Referring now to FIG. 2, the example battery pack 14 includes six battery modules 18a, 18b, 18c, 18d, 18e, 18f disposed along an axis A. The pack 14 further includes a base plate 60, end plates 62, end frames 64, control modules 68, a coolant supply 70 and coolant manifolds 74 and 78. Example control modules can include a Bussed Electrical Center and a Battery Electronic Control Module.

The battery modules 18a-18f are positioned axially between the end plates 62, which are metallic in this example. The individual battery modules 18a-18f are separated from each other by the end frames 64, which are a polymer material in this example. A tension member 80 is fastened the end plates 62. The tension member 80 limits some axial movement of the battery modules 18a-18f and the end frames 64.

Referring now to FIG. 3 with continuing reference to FIG. 2, the example battery module 18b includes a battery cell 88 axially adjacent the end frame 64′ in a direction D. Progressing along the direction D, the battery module 18b next includes a coolant fin 90, another battery cell 88′, a separator sheet 92, another battery cell 88″, and a coolant fin 90′. The battery cells 88, coolant fins 90, and separator sheets 92 can be held together within repeating frames that fasten together, and to the end frames 64. The repeating frames and the end frames 64 nest together in a male-female type relationship and can fasten together with molded clips. The end frame 64′ abuts an end frame 64″ of the battery module 18c.

The battery module 18b continues to be built up in this pattern until the battery module 18b includes about twenty individual battery cells. Within the battery pack 14, another end frame 64 of the battery module 18b separates the battery module 18b from an end frame 64 of the battery module 18a. The remaining battery modules 18a, 18c, 18d, 18e, and 18f are constructed generally in the same pattern as that shown in FIG. 3. The modularity can facilitate assembly of the battery pack 14. Each module 18a-18f can include two end frames 64 sandwiching several repeating frames, cells 88, coolant fins 90, separator sheets 92 etc.

The coolant fins 90 can provide channels C to communicate coolant near the battery cells 88. In one example, the coolant fins 90 are constructed of two sheets of material with the channels C defined therebetween.

The coolant fins 90 each include a fin inlet port 100 and a fin outlet port 104. In this example, the fin inlet port 100 is an inlet that receives coolant from the inlet manifold 74. The coolant circulates through the channel C provided by the coolant fin 90. The fin outlet port 104 is an outlet that communicates coolant from the channel C to the outlet manifold 78. The coolant carries thermal energy from the battery cell or cells 88 adjacent the coolant fin 90 to cool the battery cells 88, which facilitates operating the battery cells 88 within a desired temperature range.

The coolant supply 70 provides coolant to the inlet manifold 74 and receives heated coolant from the outlet manifold 78. The heated coolant could be circulated to a heat exchanger, such as a radiator, to cool the heated coolant. The coolant then moves from the heat exchanger back to the coolant supply 70.

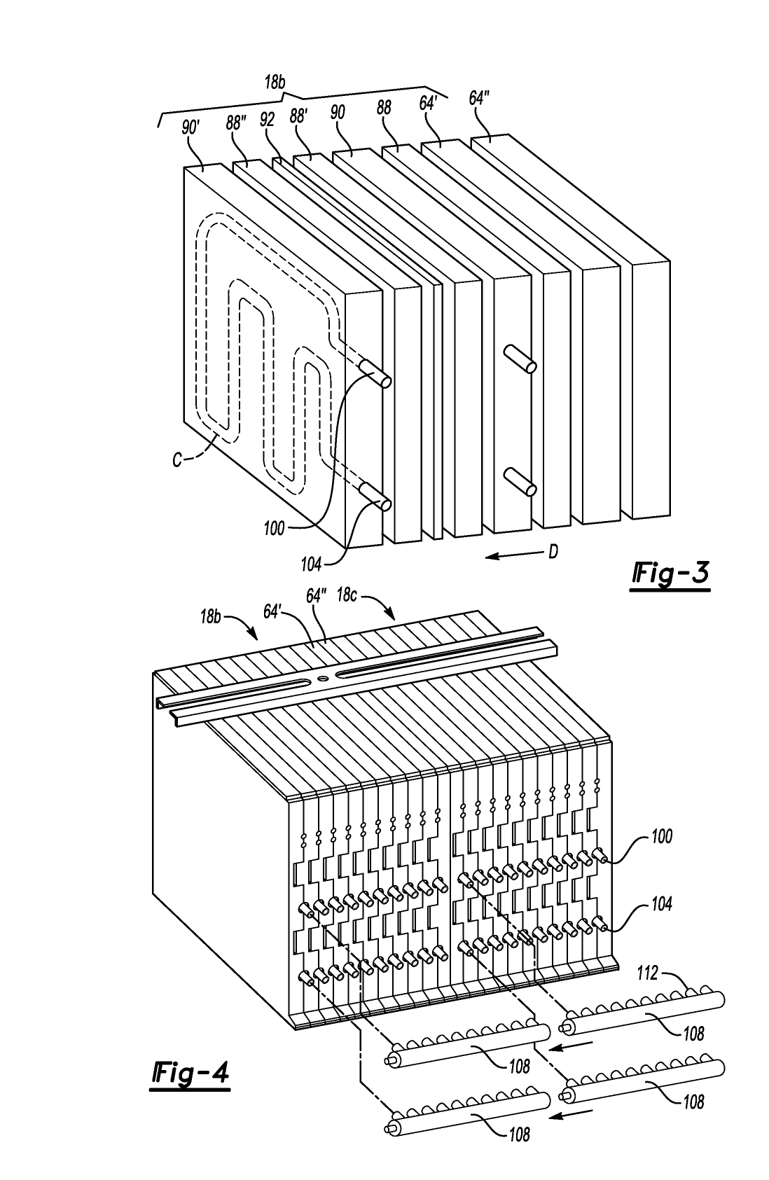

Referring now to FIG. 4 with continuing reference to FIG. 2, the inlet manifold 74 and the outlet manifold 78 are each comprised of individual manifold sections 108. An end of one of the manifold sections 108 engages another manifold section 108 through a male/female type connector. The manifold sections 108 are moved axially toward each other to move the manifold sections 108 into an engaged position. In the engaged position, coolant can communicate through the manifold sections 108. Moving the manifold sections 108 from the engaged position can introduce coolant leak paths. Thus, maintaining the manifold sections 108 in the engaged position is desirable. Structures other than a male/female type attachment could be used to join axially adjacent manifold sections 108.

Each of the manifold sections 108 has an axial length that generally corresponds to an axial length of the battery module 18a-18f that the manifold section 108 will engage. Thus, the axial length of the manifold sections 108 of the battery pack 14 can vary. The manifold sections 108 associated with the battery module 18a could be have an axial length that is less than an axial length of the manifold sections 108 associated with the remaining battery modules 18b-18f, for example.

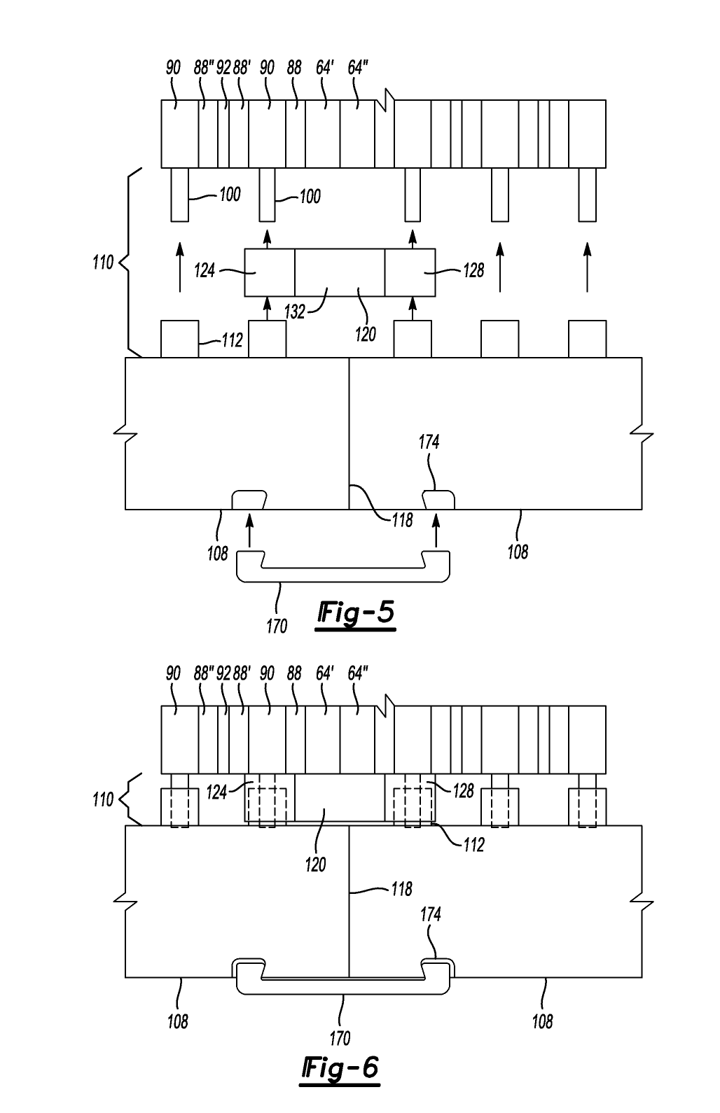

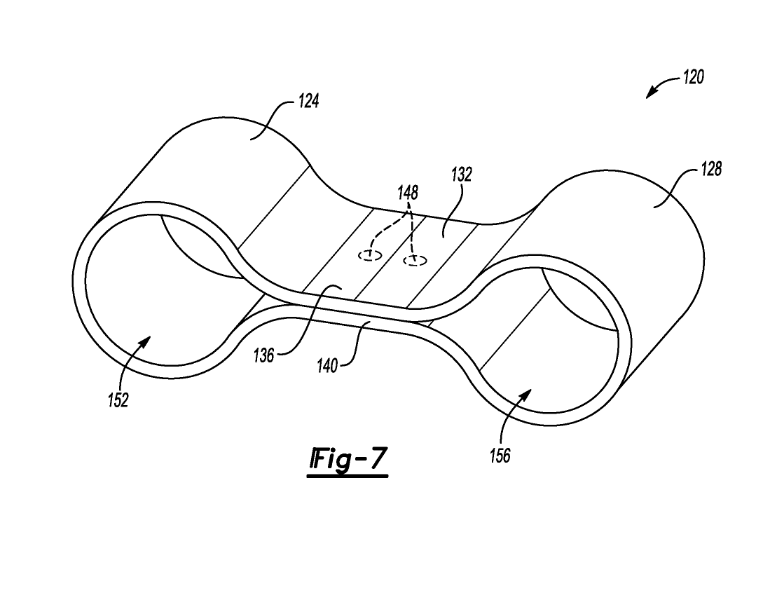

Referring now to FIGS. 5 and 6 with continuing reference to FIGS. 2 and 4, portions of the manifold sections 108 of the inlet manifold 74 are shown with portions of battery modules 18b and 18c. The manifold sections 108 couple to each of the coolant fins 90 within the battery modules 18b and 18c through port assemblies 110. The outlet manifold 74 can couple to the coolant fin 90 using a port assemblies similar in design to the port assemblies 110.

In this example, the port assembly 110 includes the fin inlet port 100 and a manifold port 112 of the manifold sections 108. Other port assemblies could omit the fin inlet port 100 and include the manifold port 112 received within an opening in the coolant fin 90. Still other port assemblies could omit the manifold port 112 and include the fin inlet port 100 received within an opening in the inlet manifold 74. As can be appreciated, many types of port assemblies 110 could be used to convey coolant between the inlet manifold 74 and the coolant fin 90.

The port assembly 110 is not limited to the specific configuration described in connection with FIGS. 5 and 6. Various arrangements could be utilized to couple the manifold sections 108 to the coolant fins 90 such that coolant can communicate between the manifolds 74 and 78, and the coolant fins 90.

In this example, each of the manifold sections 108 include ten manifold ports 112. Each of the manifold ports 112 engage a respective one of the fin inlet ports 100. The manifold ports 112 in this example, are a rubber material and the remaining portions of the manifold sections are made of a polymer material harder than the manifold ports 112. When assembling the inlet manifold 74 to the battery modules 18b and 18c the manifold ports 112 are placed over the fin inlet ports 100. The rubber material of the manifold parts 112 helps to seal interfaces between the fin inlet ports 100 and the manifold ports 112. The fin inlet ports 100 are then pressed into the manifold ports 112. In other examples, the manifold ports 112 are received within the fin outlet port 104.

As the battery cells 88 operate over time, the battery cells 88 can expand, particularly along the axis A. This expansion is, in some examples, referred to as a bulging of the battery cells 88. The expansion can introduce forces that tend to move axial adjacent ports port assemblies 110 away from each other. As can be appreciated, such movement can dislodge manifold sections 108 from their engaged positions. For example, expansion of the battery cell 88 in FIGS. 5 and 6 can urge the manifold sections 108 axially away from each other. The forces can tend to pull manifold sections 108 from the engaged position such that leak paths are introduced at the interface 118 between the manifold sections 108.

Referring to FIG. 7 with continuing references to FIGS. 5 and 6, the example battery pack 14 incorporates a battery pack retention device 120 that inhibits forces introduced by, among other things, expanding battery cells, from disrupting engagement of the manifold sections 108. The retention device 120 effectively locks the distance between axially adjacent manifold sections 108. In one example, the retention device 120 can withstand up to a 3,000 Newton tension load without yielding.

In this example, the retention device 120 includes a first loop 124, a second loop 128, and a transition section 132 coupling the first loop 124 to the second loop 128. The first loop 124, the second loop 128, and the transition section 132 are, in this example, portions of a continuous monolithic structure.

In one example, the retention device 120 is made of a stamped steel. In another example, the retention device 120 is made of an aluminum extrusion. Other materials and methods can be utilized to make the retention device 120.

The transition section 132 includes, in this example, a first layer 136 and a second layer 140. The first layer 136 joins an upper portion of the first loop 124 to an upper portion of the second loop 128. The second layer 140 joins a lower portion of the first loop 124 to a lower portion of the second loop 128.

The layers 136 and 140 can be joined at, for example, areas 148 utilizing a spot weld, or some other method of attachment. Joining the first layer 136 to the second layer 140 can strengthen the retention device 120.

In this example, the retention device 120 has a binocular or dumbbell type configuration which provides a first opening 152 spaced from a second opening 156. During assembly, the retention device 120 receives the port assembly 110 of one of the manifold sections 108 within the first opening 152 and the port assembly 110 of an axially adjacent one of the manifold sections 108 within the second opening 156.

The port assembly 110 is received within the first opening 152 such that the first loop 124 and an end portion of the transition section 132 circumscribes the port assembly 110. The other port assembly 110 is received within the second opening 156 such that the second loop 128 and another end portion of the transition section 132 circumscribes the port assembly 110. In other examples, the retention device 120 does not circumscribe the port assemblies 110.

The retention device 120 resists forces tending to move the port assemblies 110 axially away from one another. Resisting these forces with the retention device 120 inhibits the forces from pulling the manifold sections 108 away from each other and disrupting the interface 118 between the manifold sections 108, which could introduce leakage paths.

In this example, the first opening 152 slideably receives a portion of one of the fin inlet ports 100 and a portion of one of the manifold port 112. The second opening 156 slideably receives a portion of another one of fin inlet ports 100 and a portion of another one of the manifolds port 112.

The fin inlet ports 100 received within the first opening 152 and second opening 156 are associated with different coolant fins 90. The manifold port 112 received within the first opening 152 and the manifold port 112 received within the second opening 156 are associated with different manifold sections 108.

The interface 118 between the manifold sections 108 is generally aligned with the end frame 64′. Thus, the retention device 120 engages the ports assemblies 110 directly adjacent to the end frame 64′. The transition section 132 of the retention device 120 is, in this example, axially aligned with the interface 118 and the end frame 64′.

The retention device 120 could be included in other areas and associated with other port assemblies. The example inlet manifold 74 includes five interfaces 118 between adjacent manifold sections 108. One retention device 120 could be used in association with each of the five interfaces 118 of the inlet manifold 74. The example outlet manifold 78 includes five interfaces 118 between adjacent manifold sections 108. One retention device 120 could be used in association with each of the five interfaces 118 on the outlet manifold 78.

In some examples, the manifold sections 108 are further joined by a clip structure 170. The clip structure 170, in addition to the retention device 120, can further facilitate holding the manifold sections 108 in an engaged position. The clip structure 170 could be a polymer material, metallic material, or some combination of these. The clip structure 170 can engage a recessed area 174 in one of the manifold sections 108, and another recessed area 174 in the axially adjacent manifold section 108. The clip structure 170 spans the interface 118 and helps to resist movement of the manifold sections 108 from the engaged position.

Features of some of the disclosed examples include a retention device that can inhibit manifold sections from dislodging from an engaged position. The retention device effectively locks the distance between neighboring port assemblies axially adjacent interfaces between manifold sections. Locking this distance inhibits the manifold sections from disengaging.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A battery pack retention device, comprising:
a first loop configured to engage a first port assembly of a battery module;
a second loop configured to engage a second port assembly of the battery module; and
a transition section coupling the first loop to the second loop.

2. The battery pack retention device of claim 1, wherein the first loop and a first end portion of the transition section are configured to circumscribe the first port assembly.

3. The battery pack retention device of claim 2, wherein the second loop and a second end portion of the transition section are configured to circumscribe the second port assembly, the first end portion opposite the second end portion.

4. The battery pack retention device of claim 1, wherein the first loop provides an opening to slideably receive the first port assembly, and the second loop provides an opening to slideably receive the second port assembly.

5. The battery pack retention device of claim 1, wherein the first loop, second loop, and transition section are portions of a continuous, monolithic structure.

6. The battery pack retention device of claim 1, wherein the first port assembly comprises a fin port that communicates a coolant to or from a first coolant fin sandwiched between battery cells, and the second port assembly comprises a fin port that communicates a coolant to or from a second coolant fin sandwiched between battery cells.

7. The battery pack retention device of claim 1, wherein the transition section comprises a first layer and a second layer, the first layer coupling an upper portion of the first loop to an upper portion of the second loop, the second layer coupling a lower portion of the first loop to a lower portion of the second loop.

8. The battery pack retention device of claim 7, wherein the first layer is directly secured to the second layer.

9. A battery pack assembly, comprising:
a first battery module disposed along an axis;
a second battery module disposed along the axis; and
a retention device configured to engage a first port assembly of the first battery module and a second port assembly of the second battery module.

10. The battery pack of claim 9, further comprising an end frame positioned between the first and second battery modules, wherein a portion of retention device is axially aligned with the end frame.

11. The battery pack of claim 9, wherein a first coolant fin provides at least a portion of the first port assembly, and a second coolant fin provides at least a portion of the second port assembly.

12. The battery pack of claim 9, further comprising a first section of a coolant manifold engaged with a second section of the coolant manifold, wherein the first section provides at least a portion of the first port assembly and the second section provides at least a portion of the second port assembly.

13. The battery pack of claim 9, further comprising a first gasket to seal an interface of the first port assembly, and a second gasket to seal an interface of the second port assembly.

14. A battery pack manifold retention method, comprising:
coupling a first manifold section to a first coolant fin with a first port assembly;
coupling a second manifold section to a second coolant fin with a second port assembly; and
limiting relative movement between the first and second port assemblies to maintain the first manifold section in an engaged position with the second manifold section.

15. The method of claim 14, further comprising limiting by holding a portion of the first port assembly within a first loop of a retention device and by holding a portion of the first port assembly within a second loop of the retention device.

16. The method of claim 15, wherein the first port assembly and the second port assembly each comprise a fin port and a conduit port.

17. The method of claim 16, wherein the first port assembly further comprises a first gasket and the second port assembly further comprises a second gasket, the first loop directly contacting the first gasket and the second loop directly contacting the second gasket during the limiting.

18. The method of claim 15, wherein the first coolant fin is directly adjacent at least one battery cell within a first battery module disposed along an axis, and the second coolant fin is directly adjacent a battery cell within a second battery module disposed along the axis, the first battery module axially separated from the second battery module by a first end frame of the first module and a second end frame of the second battery module, the first and second end frames axially aligned with a transition section of the retention device.

19. The method of claim 14, wherein the first manifold section and the second manifold section are disclosed along a common axis when in the engaged position, and the limiting comprises limiting relative movement of the first manifold section away from the second manifold section along the axis.

20. The method of claim 14, wherein the relative movement is initiated by an expansion of at least one battery cell within a battery pack.
